(19) United States
(12) Patent Application Publication
(10) Pub. No.: US 2008/0166629 A1
(43) Pub. Date: Jul. 10, 2008

(54) Battery receptacle having two pairs of anode and cathode terminals

(76) Inventor: Wen-Chin Shiau, Kuei-Shan Hsiang (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/786,209

(22) Filed: Apr. 10, 2007

(30) Foreign Application Priority Data
Jan. 4, 2007 (TW) 096100310

(51) Int. Cl. H01M 2/02; H01M 2/26

(52) U.S. Cl. 429/169; 429/161

(57) ABSTRACT

A battery receptacle includes an insulative casing having top and bottom walls for accommodating a battery unit therebetween. A pair of first anode and cathode terminals are disposed on the top wall. An electrical contact and a pair of second anode and cathode terminals are disposed on the bottom wall. A positive-electrode connecting member interconnects electrically the first and second anode terminals, and is adapted to be in electrical contact with a positive electrode of the battery unit. The electrical contact is adapted to be in electrical contact with a negative electrode of the battery unit. A negative-electrode connecting member is connected electrically to the first and second cathode terminals and the electrical contact.

### CROSS-REFERENCE TO RELATED APPLICATION

This application claims priority of Taiwanese Application No. 096100310, filed on Jan. 4, 2007.

### BACKGROUND OF THE INVENTION

1. Field of the Invention

This invention relates to a battery receptacle, more particularly to a battery receptacle having two pairs of anode and cathode terminals.

2. Description of the Related Art

Referring to FIGS. 1 and 2, a conventional battery receptacle 1 is shown to include an insulative casing 11, an insulative cover body 12, a positive-electrode connecting member 13, a negative-electrode connecting member 15, five electrical contacts 14, an anode terminal 16, and a cathode terminal 17.

The casing 11 includes top and bottom walls 111, 112, and a surrounding wall unit 113 interconnecting the top and bottom walls 111, 112 to define an accommodating space 10 thereamong for accommodating a battery unit composed of three battery cells 2 (only one is shown).

The positive-electrode connecting member 13 has a first end portion that extends into the accommodating space 10 in the casing 11 and that is to be in electrical contact with a positive terminal of the battery unit (i.e., a positive terminal of one of the battery cells 2), and a second end portion that is disposed externally of the accommodating space 10 and that abuts against the top wall 111 of the casing 11.

The negative-electrode connecting member 15 is mounted on the casing 11, and has a lower end portion that abuts against a periphery of the bottom wall 112 of the casing 11.

The electrical contacts 14 are in the form of spiral springs, and are disposed in the accommodating space 10, wherein three of the electrical contacts 14 are mounted respectively on spring-mounting seats 115 on the bottom wall 112 of the casing 11, whereas two of the electrical contacts 14 are mounted respectively on spring-mounting seats 115 on the top wall 111 of the casing 11. Among the three electrical contacts 14 on the bottom wall 112 of the casing 11, one electrical contact 14 is to be in electrical contact with a negative terminal of the battery unit (i.e., a negative terminal of another one of the battery cells 2), and further has a strip part 142 that is in electrical contact with the lower end portion of the negative-electrode connecting member 15, whereas the other two of the electrical contacts 14 are interconnected by a conductive strip 141 (see FIG. 1). The electrical contacts 14 on the top wall 111 of the casing 11 are interconnected by a conductive strip 141 (see FIG. 2). As such, the battery cells 2 of the battery unit can be connected in series through the electrical contacts 14.

The anode terminal 16 is disposed between the top wall 111 of casing 11 and the cover body 12, and has a first end portion that projects upwardly from the cover body 12, and a second end portion that contacts electrically the second end portion of the positive-electrode connecting member 13.

The cathode terminal 17 is annular, is sleeved on an annular outer surface of the cover body 12, and is in electrical contact with an upper end portion of the negative-electrode connecting member 15.

In such a configuration, the conventional battery receptacle 1 merely has a pair of the anode and cathode terminals 16, 17 on the same side thereof such that the conventional battery receptacle has inferior applicability when installed in an electronic device.

### SUMMARY OF THE INVENTION

Therefore, the object of the present invention is to provide a battery receptacle that has two pairs of anode and cathode terminals.

According to the present invention, a battery receptacle comprises:

an insulative casing including top and bottom walls that cooperate to define an accommodating space therebetween adapted for accommodating a battery unit;

an insulative cover body mounted on the top wall of the casing and having top and bottom surfaces, and an annular outer surface that interconnects the top and bottom surfaces;

a positive-electrode connecting member having a first end portion that extends into the accommodating space and that is adapted to contact electrically a positive terminal of the battery unit, and a second end portion that is disposed externally of the accommodating space and that abuts against the top wall of the casing;

an electrical contact mounted on the bottom wall of the casing and adapted to contact electrically a negative terminal of the battery unit;

a negative-electrode connecting member disposed externally of the accommodating space and having a first end portion that abuts against a periphery of the bottom wall of the casing and that is in electrical contact with the electrical contact, and a second end portion that abuts against the top wall of the casing;

a first anode terminal having a first end portion that extends through the cover body and that projects upwardly from the top surface of the cover body, and a second end portion that projects downwardly from the bottom surface of the cover body and that is in electrical contact with the second end portion of the positive-electrode connecting member;

a first cathode terminal provided on the annular outer surface of the cover body and contacting electrically the second end portion of the negative-electrode connecting member;

a second anode terminal disposed in the accommodating space and having a first end portion that projects upwardly from the top wall of the casing and that is in electrical contact with the second end portion of the positive-electrode connecting member, and a second end portion that projects downwardly from the bottom wall of the casing; and

a second cathode terminal mounted on a bottom surface of the bottom wall of the casing and contacting electrically the electrical contact.

### BRIEF DESCRIPTION OF THE DRAWINGS

Other features and advantages of the present invention will become apparent in the following detailed description of the preferred embodiment with reference to the accompanying drawings, of which:

FIG. 1 is a partly exploded, perspective view of a conventional battery receptacle;

FIG. 2 is a schematic partly sectional view to illustrate how electrical contacts are assembled to an insulative casing of the conventional battery receptacle;

FIG. 3 is a partly exploded perspective view showing the preferred embodiment of a battery receptacle according to the present invention;

FIG. 4 is a schematic partly sectional view showing the preferred embodiment; and

FIG. 5 is a schematic partly sectional view to illustrate how battery cells are connected in series between an assembly of first and second anode terminals, and an assembly of first and second cathode terminals of the preferred embodiment.

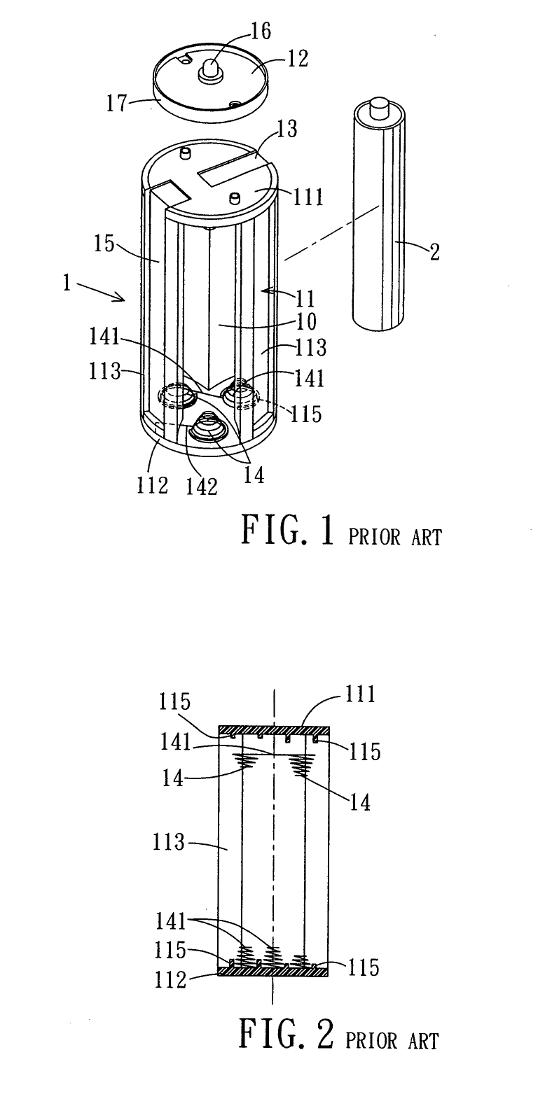

### DETAILED DESCRIPTION OF THE PREFERRED EMBODIMENT

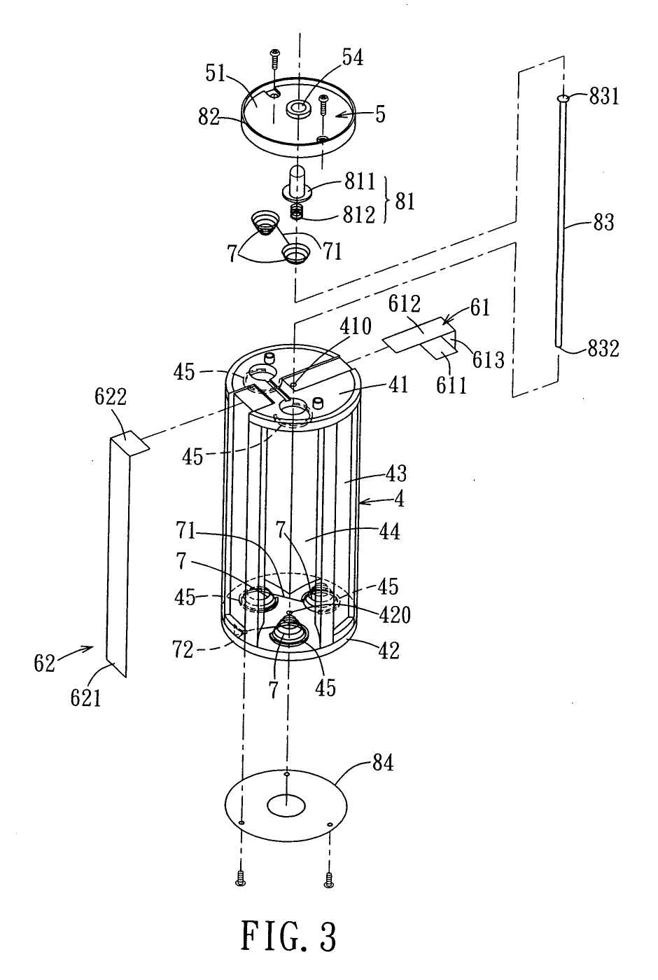

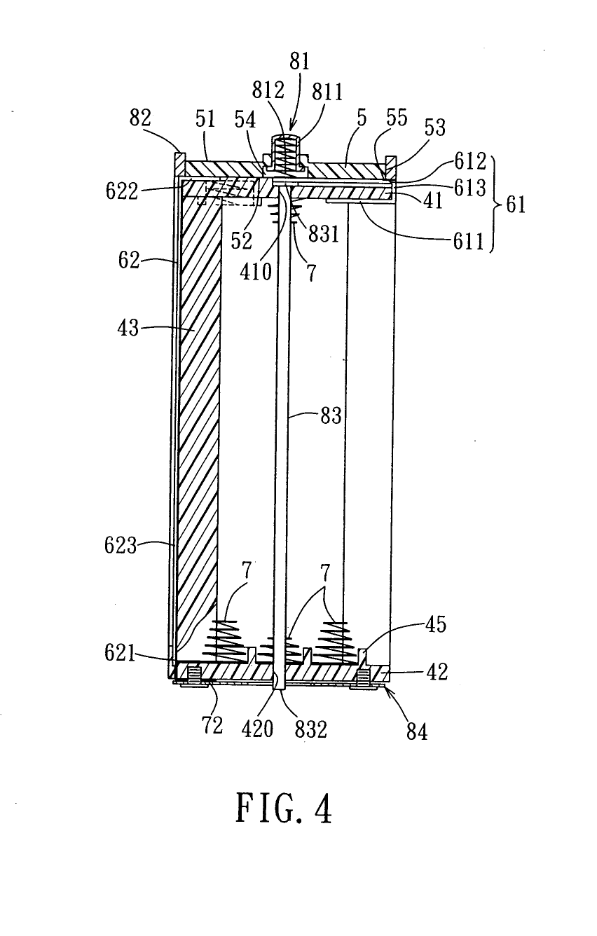

Referring to FIGS. 3 and 4, the preferred embodiment of a battery receptacle according to this invention is shown to include an insulative casing 4, an insulative cover body 5, a positive-electrode connecting member 61, five electrical contacts 7, a negative-electrode connecting member 62, a first anode terminal 81, a first cathode terminal 82, an insulating protrusion 55, a second anode terminal 83, and a second cathode terminal 84.

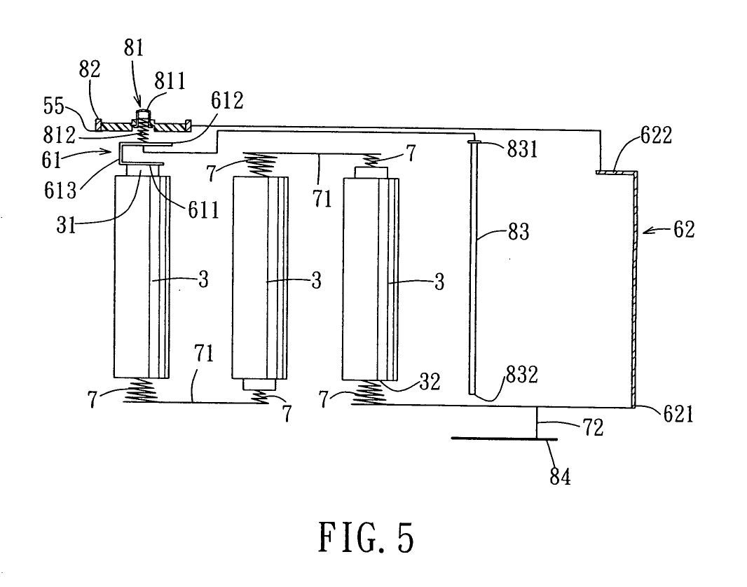

The casing 4 includes top and bottom walls 41, 42, and a surrounding wall unit 43 interconnecting the top and bottom walls 41, 42 of the casing 4 to define an accommodating space 44 thereamong adapted for accommodating a battery unit. In this embodiment, the battery unit includes three battery cells 3 (see FIG. 5). Each of the top and bottom walls 41, 42 is generally circular in shape, and is formed with a central hole 410, 420. The top wall 41 of the casing 4 has a bottom surface formed with two spring-mounting seats 45. The bottom wall 42 of the casing 4 has a top surface formed with three spring-mounting seat 45.

The cover body 5 is mounted on the top wall 41 of the casing 4, and has top and bottom surfaces 51, 52, and an annular outer surface 53 interconnecting the top and bottom surface 51, 52. In this embodiment, the cover body 5 is formed with a through hole 54.

The positive-electrode connecting member 61 has a first end portion 611 that extends into the accommodating space 44 and that is adapted to contact electrically a positive terminal 31 of the battery unit (i.e., the positive terminal 31 of one of the battery cells 3), as shown in FIG. 5, and a second end portion 612 that is disposed externally of the accommodating space 44 and that abuts against a top surface of the top wall 41 of the casing 4. In this embodiment, the positive-electrode connecting member 61 is generally U-shaped, and includes a first plate that serves as the first end portion 611 of the positive-electrode connecting member 61 and that abuts against a bottom surface of the top wall 41 of the casing 4, a second plate that serves as the second end portion 612 and that is parallel to the first plate, and a third plate 613 that interconnects the first and second plates, that is perpendicular to the first and second plates and that abuts against a periphery of the top wall 41 of the casing 4.

In this embodiment, the electrical contacts 7 are each in the form of a spiral spring, wherein two of the electrical contacts 7 are mounted respectively on the spring-mounting seats 45 on the top wall 41 of the casing 4, whereas three of the electrical contacts 7 are mounted respectively on the spring-mounting seats 45 on the bottom wall 42 of the casing 4. Among the three electrical contacts 7 on the bottom wall 42 of the casing 4, one electrical contact 7 is adapted to contact electrically a negative terminal 32 of the battery unit (i.e., the negative terminal 32 of another one of the battery cells 3), as shown in FIG. 5, and has a conductive strip part 72 extending externally of the accommodating space 44 along an outer surface of the bottom wall 42 of the casing 4, as best shown in FIG. 4, whereas the other two of the electrical contacts 7 are interconnected by a conductive strip 71. Similarly, the electrical contacts 7 on the top wall 41 of the casing 4 are interconnected by a conductive strip 71. As such, the battery cells 3 of the battery unit can be connected in series through the electrical contacts 7 and the conductive strips 71, as shown in FIG. 5.

The negative-electrode connecting member 62 is disposed externally of the accommodating space 44, and has a first end portion 621 that abuts against a periphery of the bottom wall 42 of the casing 4 and that is in electrical contact with the conductive strip part 72 of said one of the electrical contacts 7 on the bottom wall 42 of the casing 4, and a second end portion 622 that abuts against the top surface of the top wall 41 of the casing 4.

The first anode terminal 81 is disposed between the cover body 5 and the top wall 41 of the casing 4. The first anode terminal 81 has a first end portion 811 that is in the form of a cap-shaped terminal part, that extends through the through hole 54 in the cover body 5, and that projects upwardly from the top surface 51 of the cover body 5, and a second end portion that is in the form of a resilient terminal part, such as a coil spring, that projects downwardly from the bottom surface 52 of the cover body 5, and that is in electrical contact with the second end portion 612 of the positive-electrode connecting member 61, as shown in FIG. 4.

The first cathode terminal 82 is annular, is sleeved on the annular outer surface 53 of the cover body 5, and contacts electrically the second end portion 622 of the negative-electrode connecting member 62.

The insulating protrusion 55 is provided on the bottom surface 52 of the cover body 5, and abuts against the second end portion 612 of the positive-electrode connecting member 61 such that a gap is defined between the first cathode terminal 82 and the second end portion 612 of the positive-electrode connecting member 61, thereby separating the first cathode terminal 82 from the second end portion 612 of the positive-electrode connecting member 61.

The second anode terminal 83 is in the form of an elongate conductive rod, and is disposed in the accommodating space 44. The second anode terminal 83 has a first end portion 831 that extends through the central hole 410 in the top wall 41 of the casing 4, that projects upwardly from the top wall 41 of the casing 4, and that is in electrical contact with the second end portion 612 of the positive-electrode connecting member 61, and a second end portion 832 that extends through the central hole 420 in the bottom wall 42 of the casing 4 and that projects downwardly from the bottom wall 42 of the casing 4, as shown in FIG. 4.

The second cathode terminal 84 is in the form of a flat conductive ring, is mounted on a bottom surface of the bottom wall 42 of the casing 4, and contacts electrically the conductive strip part 72 of said one of the electrical contacts 7 on the bottom wall 42 of the casing 4.

In actual use, at least one of the first and second anode terminals 81, 83, and at least one of the first and second cathode terminals 82, 84 are adapted to be connected electrically to an external electronic device (not shown). Furthermore, the first anode terminal 81 and the first cathode terminal 82 are located at a top side of the battery receptacle of this invention, whereas the second anode terminal 83 and the second cathode terminal 84 are located at a bottom side of the battery receptacle. Therefore, the battery receptacle of this invention has superior applicability during use.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A battery receptacle, comprising:
an insulative casing including top and bottom walls that cooperate to define an accommodating space therebetween adapted for accommodating a battery unit;
an insulative cover body mounted on said top wall of said casing and having top and bottom surfaces, and an annular outer surface that interconnects said top and bottom surfaces;
a positive-electrode connecting member having a first end portion that extends into said accommodating space and that is adapted to contact electrically a positive terminal of the battery unit, and a second end portion that is disposed externally of said accommodating space and that abuts against said top wall of said casing;
an electrical contact mounted on said bottom wall of said casing and adapted to contact electrically a negative terminal of the battery unit;
a negative-electrode connecting member disposed externally of said accommodating space and having a first end portion that abuts against a periphery of said bottom wall of said casing and that is in electrical contact with said electrical contact, and a second end portion that abuts against said top wall of said casing;
a first anode terminal having a first end portion that extends through said cover body and that projects upwardly from said top surface of said cover body, and a second end portion that projects downwardly from said bottom surface of said cover body and that is in electrical contact with said second end portion of said positive-electrode connecting member;
a first cathode terminal provided on said annular outer surface of said cover body and contacting electrically said second end portion of said negative-electrode connecting member;
a second anode terminal disposed in said accommodating space and having a first end portion that projects upwardly from said top wall of said casing and that is in electrical contact with said second end portion of said positive-electrode connecting member, and a second end portion that projects downwardly from said bottom wall of said casing; and
a second cathode terminal mounted on a bottom surface of said bottom wall of said casing and contacting electrically said electrical contact.

2. The battery receptacle as claimed in claim 1, wherein:
said second anode terminal is in the form of an elongate conductive rod;
each of said top and bottom walls of said casing is generally circular in shape, said top wall of said casing being formed with a central hole for permitting extension of said first end portion of said second anode terminal therethrough, said bottom wall of said casing being formed with a central hole for permitting extension of said second end portion of said second anode terminal; and
said second cathode terminal is in the form of a flat conductive ring.

3. The battery receptacle as claimed in claim 1, wherein said electrical contact is in the form of a spiral spring, and has a conductive strip part extending externally of said accommodating space along an outer surface of said bottom wall of said casing and contacting electrically said first end portion of said negative-electrode connecting member and said second cathode terminal.

4. The battery receptacle as claimed in claim 1, wherein:
said first and second end portions of said first anode terminal are in the form of a cap-shaped terminal part and a resilient terminal part, respectively; and
said cover body is formed with a through hole for permitting extension of said cap-shaped terminal part of said first anode terminal therethrough.

5. The battery receptacle as claimed in claim 1, wherein said positive-electrode connecting member is generally U-shaped, and includes
a first plate that serves as said first end portion of said positive-electrode connecting member, that abuts against said top wall of said casing, and that is adapted to contact electrically the positive terminal of the battery unit,
a second plate that serves as said second end portion of said positive-electrode connecting member, that is parallel to said first plate, that abuts against said top wall of said casing, and that is in electrical contact with said second end portion of said first anode terminal, and
a third plate that interconnects said first and second plates, that is perpendicular to said first and second plates, and that abuts against a periphery of said top wall of said casing.

6. The battery receptacle as claimed in claim 1, wherein said first cathode terminal is annular and is sleeved on said annular outer surface of said cover body, said battery receptacle further comprising:
an insulating protrusion provided on said bottom surface of said cover body and abutting against said second end portion of said positive-electrode connecting member such that a gap is defined between said first cathode terminal and said second end portion of said positive-electrode connecting member.
